(19) United States
(12) Patent Application Publication
(10) Pub. No.: US 2002/0104219 A1
(43) Pub. Date: Aug. 8, 2002

(54) PISTACHIO NUT EXTRACTOR

(76) Inventor: Nels Eric Olson, Aurora, IL (US)

Correspondence Address: Mr. Marc D. Machtinger, Esq., Law Offices of Marc D. Machtinger, Ltd., 750 W. Lake Cook Road,, Ste. 350, Buffalo Grove, IL, 60089, US

(21) Appl. No.: 09/779,776

(22) Filed: Feb. 8, 2001

(51) Int. Cl. A47J 43/26; B26B 17/00

(52) U.S. Cl. 30/120.1; 30/113.2

(57) ABSTRACT

An opener for pistachio nuts which uses a multiple prong approach to remove the shell halves from a pistachio nut. By using a multiple prong approach which start in a juxtapose position, the pistachio nut is opened with an evenly applied force. The multiple prong approach also provides a space in which the meat of the nut can be captured upon returning to a closed position. The ability to grab the meat of the nut upon returning to the closed position is the reason that the name of “Pistachio Nut Extractor” was chosen over “Pistachio Nut Opener”.

### BACKGROUND OF THE INVENTION—FIELD OF INVENTION

This invention relates to a hand held extracting device. More particularly, this invention uses a novel approach to remove the shell of pistachio nuts which have a small to large crack in their shells. In addition to the novel method of removing the shells, this device also has the novel feature of being able to grab the meat of the pistachio after the shell halves are removed.

### BACKGROUND—DESCRIPTION OF PRIOR ART

A number of devices have been created to open the pistachio nut. Each device is design to enter a crack in the shell and pry apart the two halves of the shell leaving the meat of the nut accessible for human consumption. The crack in the pistachio shell is caused from the natural maturing of the nut and/or human intervention. Without the use of a pistachio nut opener/pistachio nut extractor consumers are force to open the pistachio nut with their fingernails. The use of the fingernails can result in broken fingernails.

Looking at prior devices U.S. Pat. No. 4,317,281 invented by Anthony Yowa addresses the pistachio nut directly by creating a pocket-sized nut opener. This nut opener is spoon shaped and contains a flat tab for the user to hold. On the spoon shaped end a sharp pointed tip is used to enter the crack of a pistachio nut. Once entered into the crack it is manipulated to remove the shell halves from the meat of the nut. U.S. Pat. No. 4,462,156 invented by Patricia J. Himelhoch uses a pair of levers which are attached to two pointed ends which are sharp and concave in shape. When at rest on of the ends sits on top of the other end creating a wedge which can enter an opening in a pistachio nut. Once inside the nut, the device is squeezed separating the two ends which split apart the two halves of the shell. U.S. Pat. No. 5,339,524 invented by Kenneth C. Sawyer III and Mark C. Esbenson approach opening the pistachio nut in a similar fashion in which their device is squeezed in order to separate the two halves of the pistachio shell. Their device varies in the method of entry. Instead of creating a wedge formed by one end sitting on top of the other end, their device consists of two ends that sit next to one another to form the wedge.

### SUMMARY OF THE INVENTION

The present invention provides a novel approach to open the pistachio nut while also adding the novel feature of being able to extract the meat of the nut. Comprising of more then two prongs which line up to form a single wedge enables the present invention to enter a crack in a pistachio nut easily. One novel function of the multiple prong approach is the ability to open the pistachio shell halves evenly without causing the pistachio nut to twist. This occurs when a minimum of two prongs are pushing on one half of the shell and one prong which is located between the two opposing prongs is pushing on the other half. After breaking apart the shell halves, the nut is free to fall into the consumers hand. The multiple prong approach provides an additional novel feature of being able to extract the meat of the nut. The multiple prongs after breaking apart the shell halves form a V shape. This V shape provides a location where the meat of the nut can be captured as the prongs return to their closed state.

### BRIEF DESCRIPTION OF THE DRAWINGS

FIG. 1 Shows the side view of the present invention when no force is applied and its preferred relation to a pistachio nut with the side of the pistachio facing the wedge of the present invention.

FIG. 2 Shows the side view of the present invention with force being applied to break open the pistachio nut.

FIG. 3 Shows the “meat” of the pistachio trapped by the top and bottom prongs of the present invention after the shell halves were broken off.

FIG. 4 Shows the spring in detail and how the top and bottom portions of the invention fit together.

FIG. 5 Indicates an alternate method to initial enter the shell of the pistachio when the crack is too small for the wedge formed by the top and bottom prongs to fit inside.

FIG. 6 Shows the side views of the top and bottom levers separated from each other.

FIG. 7 Shows the top and bottom views respectively of the top and bottom levers.

### DETAILED DESCRIPTION OF THE INVENTION

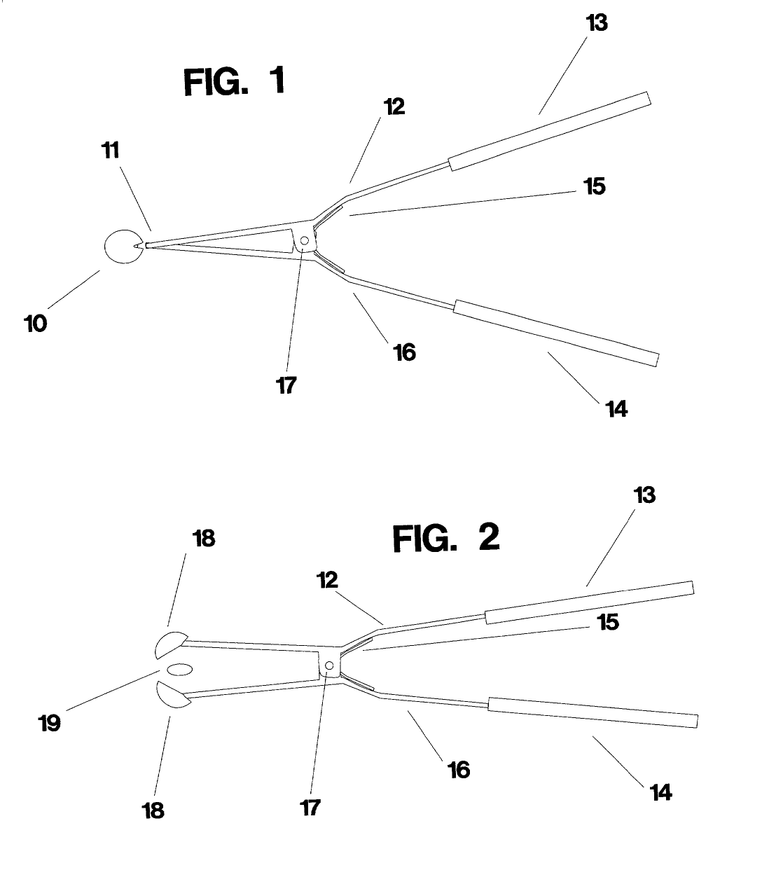

In FIG. 1 a side view of the invention shows the preferred method of entry into the pistachio nut. The pistachio nut is turned either front to back or back to front with one hand, thus exposing the side of the pistachio 10 to the wedge 11 of the device held by the users other hand. FIG. 7 illustrates the two separate levers used to form the wedge. Lever 12 has three prongs and lever 16 has two prongs. When the invention is at rest a wedge is formed by the two prongs of lever 16 and the three prongs of lever 12. These five prongs sit in juxtapose position. Using more then two prongs or ends to form a juxtapose position is a novel approach to open a pistachio nut. By using more then two prongs the force which cracks open the shell halves is applied more evenly and with less twisting of the pistachio nut. Less twisting of the pistachio nut enables the user of the present invention to have more control and benefits the user by being easier to use.

FIG. 2 shows a side view of the invention when a force is applied using the handles 13 & 14. This force causes the shell halves 18 to split apart revealing the meat of the nut. The handles are made of either plastic or rubber to minimize slipping. The spring 15 provides the resistance building up the force needed to return the handle to a resting position shown in FIG. 1. Holding the two levers 12 & 16 together is a pin 17.

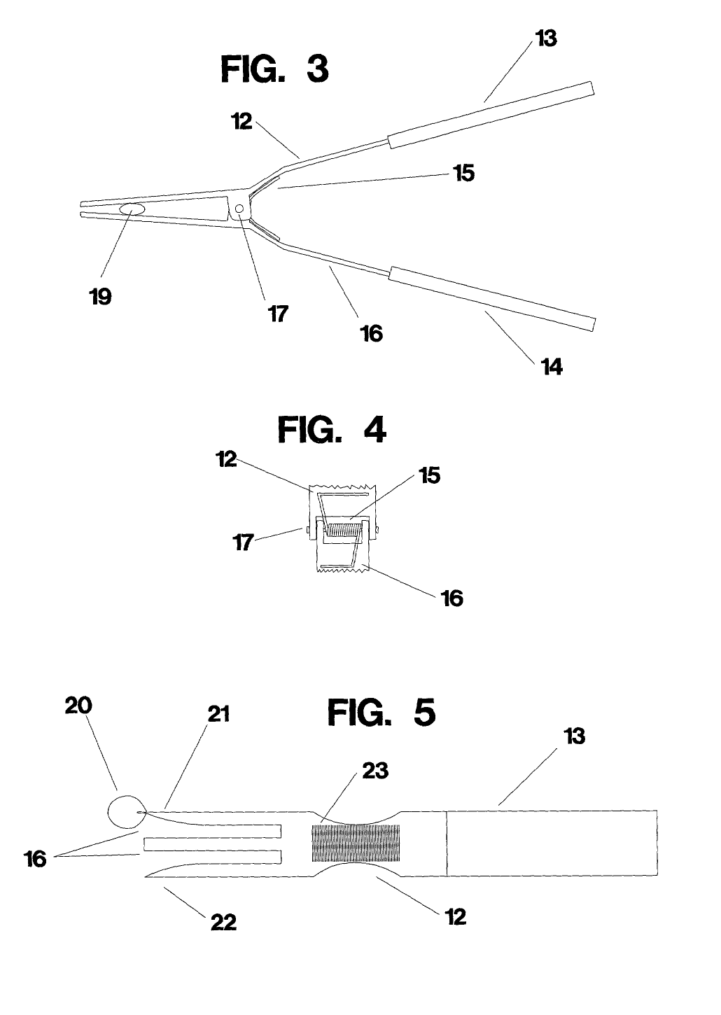

An additional novel feature of this invention is its ability to trap the meat of the nut. FIG. 3 shows the meat of the nut 19 trapped between the top lever 12 and the bottom lever 16. The trapping of the nut occurs when a slight motion forward as well as the squeezing motion are used to force the shell halves apart. Just as the shell halves separate from each other the user then can release the energy built up by the spring 15 allowing the prongs of levers 12 and 16 to close on the meat of the nut.

FIG. 4 shows a detail of the spring 15 and how the two levers 12 and 16 fit together. Lever 12 fits snugly over lever 16. This tight relationship keeps lever 12 and lever 16 inline and allows for the 5 prongs to interlock forming a wedge 11 when at rest shown in FIG. 1.

FIG. 5 shows a top view of lever 12. The two outer prongs 21 and 22 come to a point. These pointed ends allow the user to open pistachio nuts 20 whose openings are not large enough to fit the entire wedge 11 show in FIG. 1. The shape edge 21 or 22 is inserted into the small crack in the pistachio nut. The user then continues to hold the pistachio in one hand while twisting the device with the other hand. By inserting one prong and twisting the user is creating a larger crack in which to fit the other prongs of the wedge 11 into the opening. Once the wedge 11 is in place force can be applied on the handles 13 & 14 to split apart the shell halves 18. The bends 23 in the levers 12 & 16 can be seen in FIGS. 1, 2, 3, & 6 and are illustrated in FIG. 7 and FIG. 5.

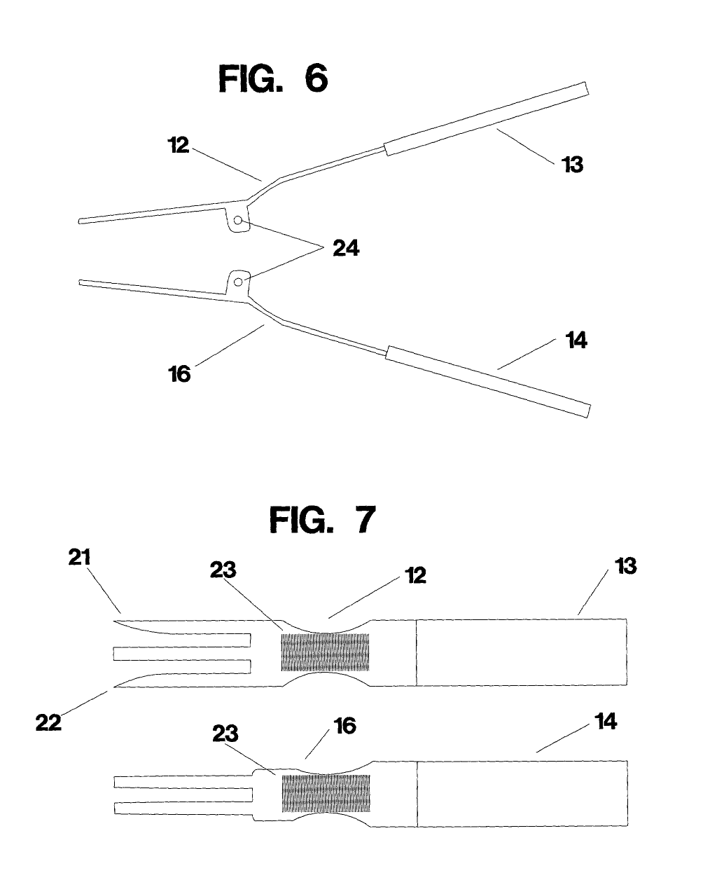

FIG. 6 and FIG. 7 show the side views and top views of the levers 12 and 16. In FIG. 6 holes 24 can be seen, these holes are where pin 17 fits through. As stated earlier the two prongs 21 & 22 shown in FIG. 7 come to a point. These points have an additional purpose other then splitting a pistachio nut with a small crack. They are designed in such a manner that the prongs 25 on lever 16 make contact with prongs 21 & 22 at the precise moment the wedge 11 as shown in FIG. 1 is formed.

I claim as my invention:

1. A nut extractor comprising:
a pair of resilient levers
multiple prongs which extend out of the two levers
the multiple prongs line up in a juxtapose position forming a wedge
multiple prongs provide a trap for the “meat” of the nut after the shell halves are broken away
